(19) United States
(12) Patent Application Publication
(10) Pub. No.: US 2006/0077277 A1
(43) Pub. Date: Apr. 13, 2006

(54) Image capturing apparatus and image capturing method

(75) Inventors: Ryuichi Kitaoka, Sakai-shi (JP); Toshihisa Maeda, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/055,443

(22) Filed: Feb. 10, 2005

(30) Foreign Application Priority Data
Oct. 7, 2004 (JP) JP2004-294393

(51) Int. Cl. H04N 3/14

(52) U.S. Cl. 348/312

(57) ABSTRACT

An image capturing apparatus includes an image sensor such as a CCD, and a timing generator for outputting electronic shutter pulse signals (SUB pulse signals) which are used for changing a potential of an overflow drain (OFD) in the image sensor. The timing generator outputs normal SUB pulses to the image sensor during live view display and outputs inverted SUB pulses obtained by inverting a phase of the normal SUB pulses to the image sensor during a time period from a time when an instruction for photographing is given (S2 state is established) to a time when exposure is started. As a result, charges can be released from the OFD for a relatively long time before exposure for photographing, so that blooming can be satisfactorily suppressed with a simple circuit configuration.

This application is based on application No. 2004-294393 filed in Japan, the contents of which are hereby incorporated by reference.

### BACKGROUND OF THE INVENTION

1. Field of the Invention

The present invention relates to an image capturing technique utilizing an image sensor which includes an overflow drain for releasing charges stored in a photoelectric converter.

2. Description of the Background Art

A digital camera (image capturing apparatus) includes a structure of a potential which is generally called an overflow drain (OFD) in a photoelectric converter of a CCD (image sensor). By inclusion of the OFD, saturation of charges in the photoelectric converter is prevented, to thereby suppress blooming. Specifically, the digital camera is designed such that excess charges generated in the photoelectric converter as a result of excessive photoelectric conversion which is likely to occur in photographing a subject with a high brightness or in other similar situations are drawn into a substrate, to be prevented from flowing into another pixel or a path for charge transfer (charge transfer path).

A potential of the OFD can be changed by pulse signals for implementing electronic shuttering (SUB pulse signals), which are fed by a timing generator. The SUB pulse signals are used for exposure control which can be also referred to as electronic shuttering. However, a potential of an entire image sensor is changed upon input of a pulse signal for changing the potential of the OFD in SUB pulse signal sequence. As such, if a SUB pulse signal in SUB pulse signal sequence is input during charge transfer, the charge transfer cannot be properly accomplished. As a result, a noise is generated in an image. For this reason, in general, a SUB pulse signal which enables a change of the potential of the OFD (which signal will hereinafter be simply referred to as an “ON signal”) is input at a moment when charge transfer is paused in both a vertical transfer path and a horizontal transfer path, which moment occurs once per period of scanning of one horizontal line.

Another technique for anti-blooming is to perform a sweep of a first field before reading out a signal charge for a longer time than that is taken for a sweep of a second field. This technique allows increase in an amount of charges transferred during a sweep of the first field, so that blooming can be suppressed.

However, the foregoing technique cannot always satisfactorily suppress blooming because only an extremely short time period can be used for changing a potential of an OFD for releasing charges, and only a period of a sweep of the first field can be extended. Particularly, in recent days, there is a trend toward a shorter pixel pitch with increase in the number of pixels in an image sensor. Thus, a MOS capacitor of a photoelectric converter has become smaller and a space between adjacent pixels has become shorter, to create circumstances which permit blooming to more easily occur. Under such circumstances, it is considered difficult to satisfactorily eliminate blooming by using the foregoing technique.

### SUMMARY OF THE INVENTION

The present invention is directed to an image capturing apparatus.

According to the present invention, the image capturing apparatus includes: an image sensor including an overflow drain for releasing charges stored in a photoelectric converter functioning to perform photoelectric conversion; and a driver for outputting a drive signal for controlling a potential of the overflow drain, to the image sensor. In the image capturing apparatus, the driver outputs a first pulse signal as the drive signal in a first state related to capturing an image of a subject, and the driver outputs a second pulse signal as the drive signal in a second state different from the first state, the second pulse signal being obtained by inverting a phase of the first pulse signal. Accordingly, it is possible to satisfactorily suppress blooming depending on each situation, with a simple circuit configuration.

According to a preferred embodiment of the present invention, the image capturing apparatus further includes a display for displaying an image. The first state occurs in a period during which the image is displayed on the display, and the second state occurs in a period from a time when an instruction for photographing is given to a time when exposure is started. Accordingly, it is possible to satisfactorily suppress blooming during photographing.

The present invention is also directed to an image capturing method.

It is therefore an object of the present invention to provide an image capturing technique which satisfactorily suppresses blooming with a simple circuit configuration.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 illustrate an appearance of an image capturing apparatus according to a preferred embodiment of the present invention.

FIG. 3 is a functional block diagram of the image capturing apparatus.

FIG. 4 is a view for explaining functions of an image sensor.

FIG. 5 illustrates a structure of an image sensor driving circuit.

FIG. 6 is a timing chart for explaining operations of the image capturing apparatus.

### DESCRIPTION OF THE PREFERRED EMBODIMENTS

Structure of Image Capturing Apparatus

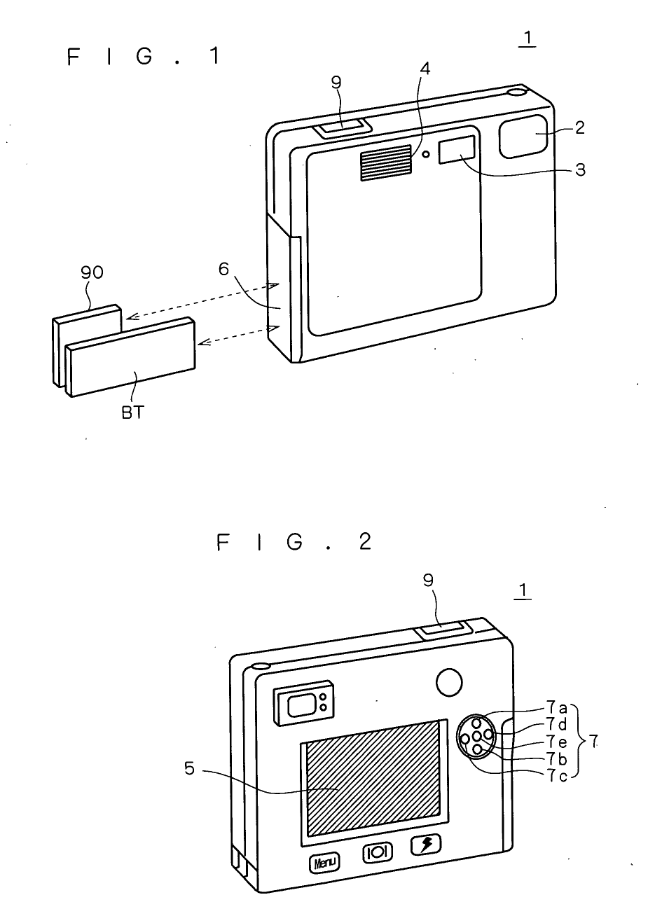

FIGS. 1 and 2 illustrate an appearance of an image capturing apparatus 1 according to a preferred embodiment of the present invention. FIG. 1 is a schematic perspective view of the image capturing apparatus 1 when viewed from the front, and FIG. 2 is a schematic perspective view of the image capturing apparatus 1 when viewed from the back.

The image capturing apparatus 1 is configured to function as a digital camera, for example. The image capturing apparatus 1 includes a taking lens 2, an optical finder 3, and an electronic flash 4 on a front face thereof, and also includes a shutter release button 9 on a top face thereof.

The image capturing apparatus 1 further includes a liquid crystal display (which will be hereinafter simply referred to as a “display”) 5 and a group of buttons 7 on a back face thereof. The group of buttons 7 includes cursor buttons 7a, 7b, 7c, 7d, and 7e arranged in a cross.

The shutter release button 9 is a two-position push-button switch which can be placed in two distinguishable and detectable states of: a state where the shutter release button 9 is pressed halfway down by a photographer (which will be hereinafter also referred to as a “state S1”); and a state where the shutter release button 9 is fully pressed down by a photographer (which will be hereinafter also referred to as a “state S2”). In the state (S1 state) where the shutter release button 9 is pressed halfway down, automatic focus control is initiated. In the state (S2 state) where the shutter release button 9 is fully pressed down, photographing for capturing a still image which is to be recorded is initiated.

The display 5 is used for display of a preview image (which can be also referred to as “live view display”) of a subject, playback of a recorded image, and the like.

For live view display, after the image capturing apparatus 1 is powered or photographing is once finished, an image of a subject is repeatedly captured every 1/30 second with a low resolution, and the captured images are displayed in an animated manner on the display 5. In this manner, a photographer acknowledges a position, a size, and the like of the subject in the captured images, so that he can carry out framing.

A lid 6 is provided to cover a battery compartment and a memory card pocket. In other words, the battery compartment accommodating a battery BT for supplying a power and the memory card pocket into which a memory card 90 serving as a removable recording medium is inserted are provided inside the lid 6. Image data or the like provided as a result of photographing is recorded in the memory card 90 inserted into the memory card pocket.

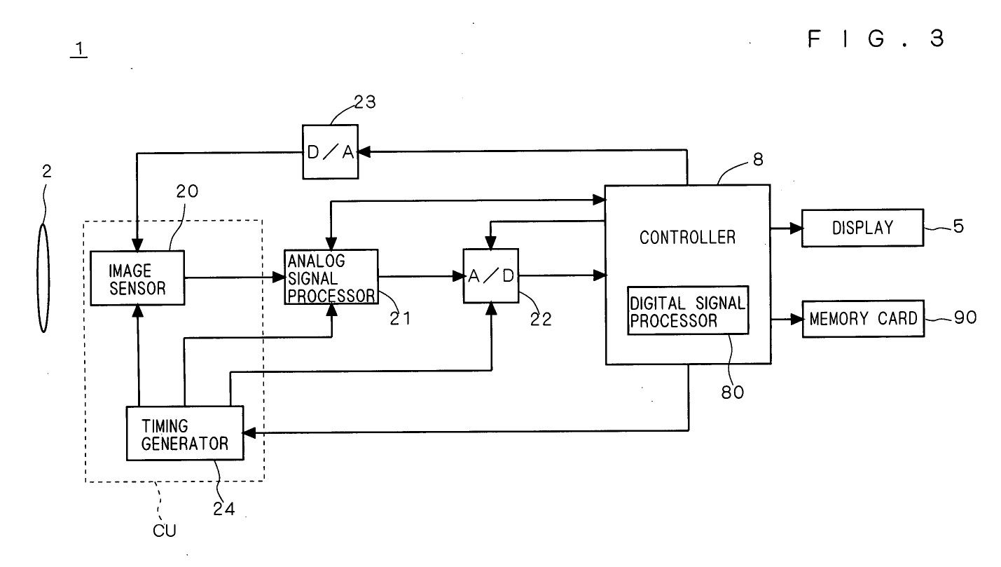

FIG. 3 is a functional block diagram of the image capturing apparatus 1.

An image sensor 20 is configured to function as a CCD (Charge Coupled Device), for example. The image sensor 20 captures an image of a subject and generates an electronic image signal. More specifically, the image sensor 20 performs photoelectric conversion on an optical image of a subject formed by the taking lens 2, to convert the optical image into an image signal composed of red (R)-, green (G)-, and blue (B)-color components for each pixel (in other words, a signal composed of a sequence of plural pixel signals respectively received by pixels).

The image signal generated by the image sensor 20 is supplied to an analog signal processor 21, which then performs analog signal processing on the supplied image signal. More specifically, the analog signal processor 21 includes an automatic gain control (AGC) circuit. The analog signal processor 21 is capable of controlling a level of the image signal by having the automatic gain control circuit therein control a gain.

An analog-to-digital (A/D) converter 22 functions to covert each of the pixel signals forming the image signal which has been amplified by the analog signal processor 21, into a 10-bit digital signal, for example. A digital signal provided as a result of analog-to-digital conversion in the AID converter 22 is input to a digital signal processor 80 within a controller 8, and then subjected to various image processing such as white balance (WB) control, γ correction, and color correction in the digital signal processor 80.

The image data which has been subjected to the image processing in the digital signal processor 80 is displayed on the display 5, or recorded in the memory card 90.

A digital-to-analog (D/A) converter 23 converts the digital signal transmitted from the controller 8 into an analog signal, and outputs the analog signal to the image sensor 20.

A timing generator 24 functions to generate various pulses for driving the image sensor 20, the analog signal processor 21, and the A/D converter 22. The timing generator 24 is capable of outputting various kinds of drive pulses. The various kinds of drive pulses are generated based on timing pulses supplied from the controller 8.

The timing generator 24 and the image sensor 20 are formed integrally with each other in an image sensor driving circuit CU. Details of the image sensor driving circuit CU will be given later.

The controller 8 includes a CPU functioning as a computer and a memory, and comprehensively controls respective parts of the image capturing apparatus 1. Also, the controller 8 transmits a signal for selecting inversion or non-inversion of the SUB pulse signals (which will be later described in detail) in accordance with photographic conditions, to the image sensor driving circuit CU.

Functions of Image Sensor 20

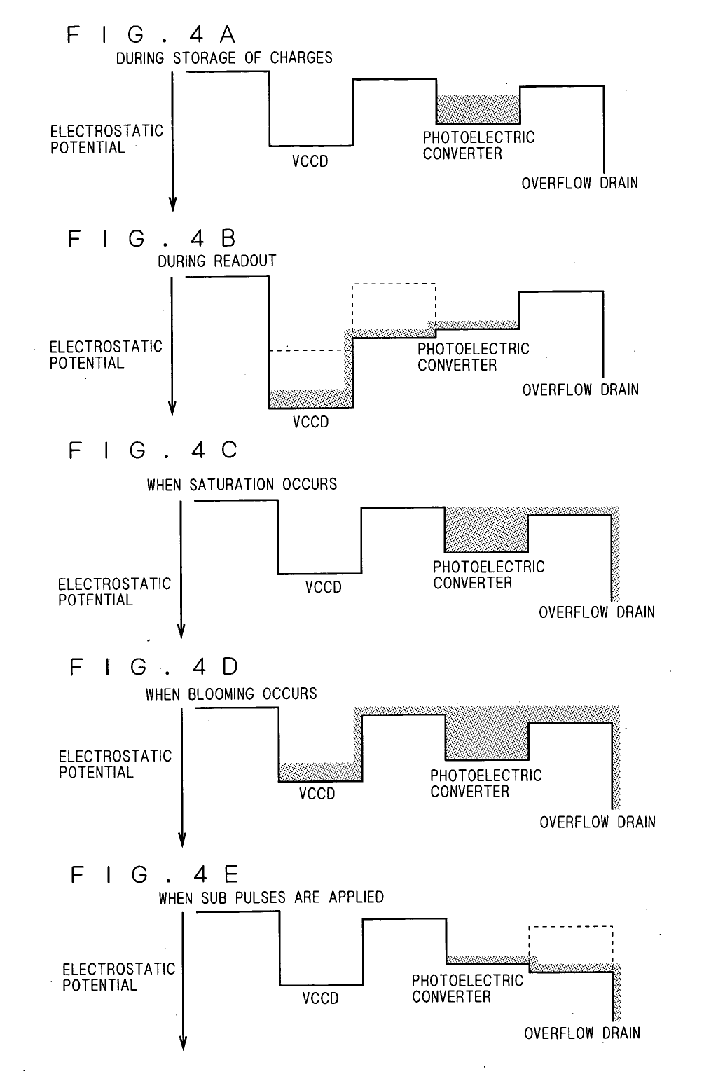

FIGS. 4A, 4B, 4C, 4D, and 4E are views for explaining functions of the image sensor 20. Each of FIGS. 4A, 4B, 4C, 4D, and 4E is a conceptual diagram of a potential of the image sensor 20, to represent a certain state of the image sensor 20.

In the image sensor 20, a light beam emitted from a subject is received through the taking lens 2, to cause photoelectric conversion in the photoelectric converter (photoelectric conversion cell) including a photo diode and a MOS capacitor. As a result, signal charges are stored (FIG. 4A).

The charges stored in the photoelectric converter are then transferred to a vertical CCD (VCCD) in response to a readout signal supplied from the timing generator 24 (FIG. 4B). Subsequently, the charges in the VCCD are sequentially read out from the VCCD in response to a CCD transfer signal, to be output.

In a case where a light emitted from a subject having a high brightness is received, or in a case where a time period for storing charges (exposure time) is much longer than a proper exposure time, excessive photoelectric conversion is performed during the photoelectric conversion in the photoelectric converter, so that charges in an amount beyond a capacity of the MOS capacitor are generated. In such case, an overflow drain (OFD) operates to release excess charges under normal conditions, as illustrated in FIG. 4C. The OFD is configured as a barrier having a potential which is a little bit higher than an electrostatic potential of a barrier between the photoelectric converter and the VCCD.

However, if charges generated in the photoelectric converter are too much to be released by the OFD, the charges flow into the VCCD or an adjacent pixel as illustrated in FIG. 4D. This phenomenon is called blooming.

At that time, by applying electronic shutter pulse signals (SUB pulse signals) functioning as driving signals for controlling the potential of the OFD to the image sensor 20, the potential of the OFD can be increased so that the charges generated in the photoelectric converter can be forced to be released, as illustrated in FIG. 4E.

According to the preferred embodiment of the present invention, in order to suppress blooming which occurs in photographing a subject with a high brightness or in other similar situations, the SUB pulse signals are inverted and input to the image sensor during photographing. The inversion of the SUB pulse signals is performed in the image sensor driving circuit CU, the structure of which will be described in detail below.

Image Sensor Driving Circuit CU

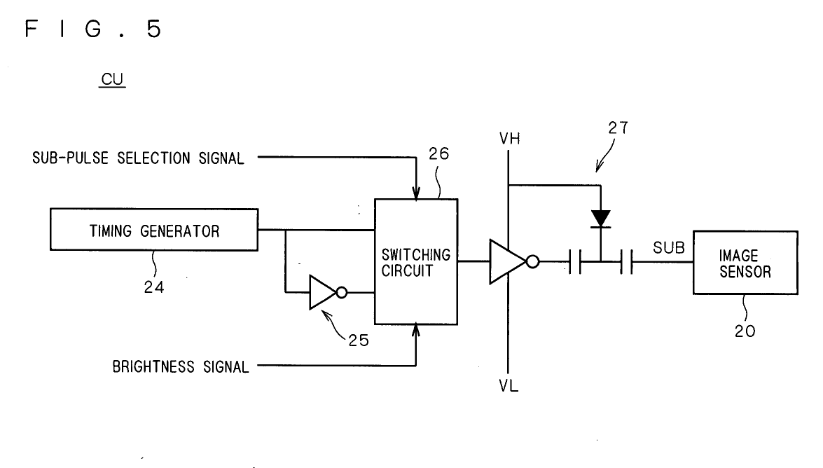

FIG. 5 illustrates a structure of the image sensor driving circuit CU.

The image sensor driving circuit CU includes the image sensor 20 and the timing generator 24 which have been described above. The image sensor driving circuit CU further includes an inverter circuit 25, a switching circuit 26, and a driver 27 for inputting SUB pulse signals output from the switching circuit 26, to the image sensor 20.

The SUB pulse signals output from the timing generator 24 are directly input to the switching circuit 26, and also, are inverted in phase thereof by the inverter circuit 25 to be input to the switching circuit 26. In the present specification, hereinafter, the SUB pulse signals directly input to the switching circuit 26 will be referred to “normal SUB pulses”, and the SUB pulse signals which are inverted and input to the switching circuit 26 via the inverter circuit 25 will be referred to “inverted SUB pulses”.

As described above, the switching circuit 26 receives two kinds of pulse signals of the normal SUB pulses and the inverted SUB pulses. For output, the switching circuit 26 selects the normal SUB pulses or the inverted SUB pulses in accordance with a SUB-pulse selection signal supplied from the controller 8 (FIG. 3), and outputs the selected pulse signals.

The image capturing apparatus 1 can generate the inverted SUB pulses by inclusion of a relatively simple circuit configuration of the image sensor driving circuit CU which includes the inverter circuit 25 and the like as described above. Next, operations of the image capturing apparatus 1 will be described.

Operations of Image Capturing Apparatus 1

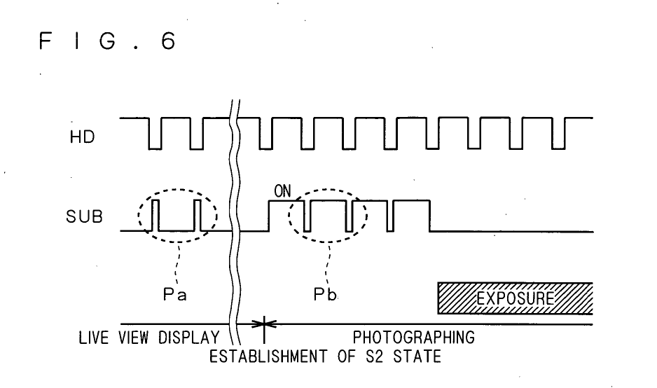

FIG. 6 is a timing chart for explaining operations of the image capturing apparatus 1. In FIG. 6, an axis representing passage of time extends in a horizontal direction, and sequences of horizontal synchronization signals HD and the SUB pulse signals are illustrated along the axis.

Referring to FIG. 6, during live view display in the image capturing apparatus 1, normal SUB pulses Pa are input to the image sensor 20. Then, during photographing, more precisely, during a time period from a time when the shutter release button 9 is fully pressed down (the S2 state is established) to a time when exposure is started, inverted SUB pulses Pb are input to the image sensor 20.

It should be noted that the normal SUB pulses Pa each including an ON signal which occupies an extremely short period in an entire period of one pulse are input to the image sensor 20 during live view display (first state). The reason for this is to allow the potential of the OFD to be changed in a very short time during which neither vertical transfer nor horizontal transfer is performed as described above.

Then, in photographing, since charge transfer is not performed during a time period from a time when an instruction for photographing is given by full-press of the shutter release button 9 to a time when exposure is started, the SUB pulse signals are activated for a longer time, to thereby suppress blooming. Specifically, in each of the inverted SUB pulses Pb, a time period for release of charges (corresponding to a time period occupied by an ON signal) in an entire period of one pulse is longer than that in each of the normal SUB pulses Pa. Thus, by inputting the inverted SUB pulses Pb to the image sensor 20, it is possible to further suppress blooming in photographing.

In a situation where a subject with an extremely high brightness such as a direct sunlight is photographed, it is likely that excessive photoelectric conversion occurs even in a period of scanning of one horizontal line (approximately 0.1 to 0.15 ms), to cause blooming. Also, in recent days, as the size of an image sensor has become smaller and the number of pixels has become larger as described above, a distance between adjacent pixels has become smaller, to create circumstances which permit blooming to more easily occur.

Despite the foregoing circumstances, the image capturing apparatus 1 can satisfactorily suppress blooming with a simple circuit configuration by inputting inverted SUB pulses generated in the inverter circuit 25 in the image sensor driving circuit CU to the image sensor 20 in photographing. More specifically, in the image capturing apparatus 1, SUB pulse signals are inverted using a simple circuit, to increase the potential of the OFD in a time period during which charge transfer is not influenced in any way, i.e., a time period from a time when the shutter release button is fully pressed down to a time when exposure is started. As a result, a time period during which charges are forced to be released is extended. Hence, blooming can be satisfactorily suppressed even under the circumstances which permit blooming to easily occur.

Additionally, the normal SUB pulses or the inverted SUB pulses may alternatively be selected by the switching circuit 26 in accordance with a brightness signal illustrated in FIG. 5, in the image capturing apparatus 1. In this alternative embodiment, the brightness signal is, for example, an average brightness value of a subject, which can be obtained by the controller 8 based on image data associated with live view display. The brightness signal is input to the switching circuit 26. Then, the normal SUB pulses are output from the switching circuit 26 in photographing a subject with a low brightness, while the inverted SUB pulses are output from the switching circuit 26 in photographing a subject with a high brightness. In this manner, blooming can be satisfactorily suppressed with a simple circuit configuration even in photographing a subject with a high brightness which permits blooming to easily occur.

Modifications

In the above-described preferred embodiment, timing information about live view display or photographing may be supplied from the controller to the image sensor driving circuit CU (FIG. 3) so that selection of the normal SUB pulses or the inverted SUB pulses can be achieved based on the supplied timing information. In this alternative embodiment, the image sensor driving circuit CU, which is capable of obtaining the timing information for selection of the normal SUB pulses or the inverted SUB pulses, can function as an image capturing apparatus according to the present invention.

In the above-described preferred embodiment, the circuit configuration illustrated in FIG. 5 is not necessarily required to be implemented for inversion of the SUB pulse signals. Alternatively, timings of falling edges and timings of rising edges may be reversed by appropriately controlling settings of registers in the timing generator.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image sensor including an overflow drain for releasing charges stored in a photoelectric converter functioning to perform photoelectric conversion; and
a driver for outputting a drive signal for controlling a potential of said overflow drain, to said image sensor, wherein
said driver outputs a first pulse signal as said drive signal in a first state related to capturing an image of a subject, and
said driver outputs a second pulse signal as said drive signal in a second state different from said first state, said second pulse signal being obtained by inverting a phase of said first pulse signal.

2. The image capturing apparatus according to claim 1, wherein
a period for charge release in an entire period of one pulse of said second pulse signal is longer than a period for charge release in an entire period of one pulse of said first pulse signal.

3. The image capturing apparatus according to claim 1 further comprising
a display for displaying an image, wherein
said first state occurs in a period during which said image is displayed on said display, and
said second state occurs in a period from a time when an instruction for photographing is given to a time when exposure is started.

4. The image capturing apparatus according to claim 3, wherein
said first state occurs in a period during which said image is displayed on said display and vertical transfer and horizontal transfer are not performed in said image sensor.

5. The image capturing apparatus according to claim 1, wherein
said first state represents a state in which a subject with a low brightness is photographed, and
said second state represents a state in which a subject with a high brightness is photographed.

6. The image capturing apparatus according to claim 1 further comprising
a selector for selecting one of said first pulse signal and said second pulse signal and outputting a selected pulse signal to said image sensor.

7. An image capturing method using: an image sensor which includes an overflow drain for releasing charges in a photoelectric converter functioning to perform photoelectric conversion; and a driver for outputting a drive signal for controlling a potential of said overflow drain to said image sensor, said method comprising the steps of:
(a) outputting a first pulse signal as said drive signal in a first state related to capturing an image of a subject; and
(b) outputting a second pulse signal as said drive signal in a second state different from said first state, said second pulse signal being obtained by inverting a phase of said first signal.

8. The image capturing method according to claim 7, wherein
a period for charge release in an entire period of one pulse of said second pulse signal is longer than a period for charge release in an entire period of one pulse of said first pulse signal.
